(19) United States
(12) Patent Application Publication
(10) Pub. No.: US 2018/0208282 A1
(43) Pub. Date: Jul. 26, 2018

(54) FIRST-STAGE PRESSURE REDUCING DEVICE FOR PRESSURIZED BREATHABLE GAS

(71) Applicant: LA SPIROTECHNIQUE INDUSTRIELLE ET COMMERCIALE, Carros (FR)

(72) Inventors: Nicolas PEYRON, Saint Jeannet (FR); Stéphane CAREPA, Saint Laurent Du Var (FR)

(73) Assignee: LA SPIROTECHNIQUE INDUSTRIELLE ET COMMERCIALE, Carros (FR)

(21) Appl. No.: 15/757,890

(22) PCT Filed: Sep. 13, 2016
(86) PCT No.: PCT/FR2016/052299

§ 371 Date: Mar. 6, 2018

(30) Foreign Application Priority Data
Sep. 18, 2015 (FR) 1558790

(51) Int. Cl. B63C 11/22; F17C 13/04

(52) U.S. Cl. CPC B63C 11/2209; F17C 13/04; F17C 2201/032; F17C 2201/058; F17C 2205/0308; F17C 2270/0781; F17C 2205/0394; F17C 2221/031; F17C 2223/0123; F17C 2223/036; F17C 2205/0385

(57) ABSTRACT

Device for pressurized breathable gas for a diver, wherein the pressure reducing device (1) having a yoke (6) and includes a body (2) that houses a gas circuit (3) formed at the level of an inlet connection (9), a depressurized gas outlet, a pressure regulator (3) located between the inlet (4) and the outlet (5), a yoke (6) connected to the body (2) and supporting a clamping mechanism (7) that is mobile to the yoke (6) to for tightening or loosening of a pressurized gas source valve (8) at the inlet (4) of the body (2), the inlet connection (9) includes an upstream end around the inlet (4), the sealing region (100) includes a seal (10) and/or is designed to cooperate with a seal (10) of a valve or an adapter of a valve to seal between a valve (8) and the pressure relief device (1).

### CROSS-REFERENCE TO RELATED APPLICATIONS

This application is a U.S. 371 National Stage entry of International Application Serial No. PCT/FR2016/052299 filed Sep. 13, 2016, which claims priority to French Patent Application No. 1558790 filed Sep. 18, 2015. The contents of each of these applications are hereby incorporated herein by reference in their entirety as if set forth verbatim.

The invention relates to a first-stage pressure reducing device for pressurized breathable gas for a diver and an inlet connection of such a device.

The invention relates in particular to a first-stage pressure reducing device for pressurized breathable gas for a diver, wherein the pressure reducing device is of the type having a yoke and includes a body that houses a gas circuit including a pressurized gas inlet formed at the level of an inlet connection, an outlet for depressurized gas, a pressure regulator located between the inlet and the outlet, a yoke that is rigidly connected to the body and supports a clamping member that is movable relative to the yoke so as to ensure clamping or unclamping of a pressurized gas source valve at the level of the inlet of the body, wherein the inlet connection includes a cylindrical outer upstream end positioned around the inlet, the sealed region includes a seal and/or is designed to cooperate with a seal of a valve or an adapter of a valve to ensure a seal between a pressurized gas source valve and the pressure reducing device when the pressure reducing device is connected to a valve.

First-stage pressure reducing devices are pressure reducing devices that are detachably connected to the valve of a cylinder containing pressurized gas. The mechanical and fluid connection of a pressure reducing device of this type can be realized using two types of standardized connections. A first type of connection is commonly called a “DIN connection”. This is a connection in which the inlet connection of the pressure reducing device is screwed directly into the body of the valve.

The second type of connection is commonly called a “yoke connection”. The dive cylinder valves are designed so that they can receive both types of connections and can be converted from the first type to the second type via the use of an adapter insert which is generally screwed into the body of the valve to create the sealed connection.

When the insert is placed in the valve of the cylinder, it is possible to connect a yoke-type pressure reducing device to the valve.

Reference can be made, for example, to the standard ISO 12209:2013 which describes these two types of connections. Reference can also be made to EP1681232A1 and EP1519871A1 which describe particular examples of the yoke-type connection and the DIN-type connection pressure reducing devices.

The yoke-type connection has weaknesses due to its design. The O-ring between the inlet connection and the insert is housed in a groove located on the terminal end of the insert. This connection is designed to cooperate with a circular rib formed on the upstream terminal end of the inlet connection. In other words, the O-ring is frontally crushed against a circular rib of the inlet connection of the pressure reducing device.

This seal has a tendency to escape from its housing after repeated use, and the groove generally does not have sufficient ability to retain it.

Moreover, when the pressure reducing device is disconnected from the valve and especially when the valve is not fully purged, the residual pressure has a tendency to remove the O-ring from its groove.

In addition, when the connection is being made it is necessary to exert a large tightening torque on the screw of the yoke so that after the deformation and elastic elongation of the yoke there is no extrusion of the O-ring in its groove.

The humid atmosphere of dive centers that use pressure reducing devices of this type also promotes the unsatisfactory retention of this O-ring in its frontal groove of the insert. The compression of the O-ring in this frontal groove creates internal stresses in the elastomer of the O-ring that reduce its useful life.

This invention relates to pressure reducing devices for pressurized breathable gas designs for underwater diving, and in particular the part that reduces the pressure which is connected to the dive cylinder.

One object of the present invention is to eliminate some or all of the disadvantages of the prior art described above.

For this purpose, the pressure reducing device according to the invention, which also conforms to the general definition given in the above introduction, is essentially characterized in that the sealing region is located on the outer cylindrical periphery of the inlet connection.

In addition, embodiments of the invention can include one or more of the following characteristics:
the inlet connection has a tubular shape that extends around a central longitudinal axis, and the sealing region is located on a face of the outer cylindrical periphery of the inlet connection which is concentric and parallel to the central longitudinal axis,
the connection includes a seal located at the level of the sealing region,
the device includes an O-ring which is housed in a groove located radially on the periphery of the connection,
the seal of the connection emerges radially over the outer periphery of the connection to cooperate, forming a seal, with a wall of a tubular part located concentrically around the upstream end of the connection and of the seal,
the sealing region of the connection (9) does not have a seal, wherein the device includes an adapter insert which is one piece which is rigidly connected to a valve, said insert being designed so that it can be installed in a removable fashion on the upstream end of the inlet connection (9), wherein the insert has a tubular shape that extends around a longitudinal direction between a first upstream end and a second downstream end in the assembled position, and the first downstream end of the insert is concentrically engaged around the upstream end of the connection, and the downstream end of the insert includes an internal cylindrical wall provided with a seal that comes into sealed contact against the sealing region of the connection,
the device includes a connection adapter insert designed to be detachably installed on the upstream end of the inlet connection, wherein the insert has a tubular shape that extends around a longitudinal direction between a first upstream end and a second downstream end in the assembled position, wherein the downstream first end of the insert is engaged concentrically around the upstream end of the connection and of the seal, and the downstream end of the insert includes a cylindrical internal wall that comes into sealed contact with the seal, radially around the latter
the first upstream end of the insert is designed to cooperate in a sealed fashion in particular with a pressurized gas source valve,
the first upstream end of the insert includes an upstream seal designed to cooperate in a sealed manner in particular with a pressurized gas source valve,
in the assembled position, the second downstream end of the insert is fitted onto the upstream end of the connection, and the insert includes a threaded or tapped portion designed to cooperate with a mated portion of a source valve connected to the pressure reducing device,
the downstream terminal end of the insert includes a surface perpendicular to the longitudinal direction, wherein this surface includes at least one groove to inhibit, in the assembled position, a contact seal between the surface and a parallel mating surface of a connection,
the upstream terminal end of the inlet connection includes a surface perpendicular to the outer cylindrical periphery of the inlet connection, and said surface includes at least one groove to inhibit, in the installed position, a frontal contact seal between the surface and a mating surface of an insert or of a valve,
the inlet connection is removable fastened, in particular by screwing onto the body of the pressure reducing device, for example, and the inlet connection is threaded,
the pressure reducing device includes a yoke connected to this body either detachably or non-detachably,
when the pressure reducing device is in the assembled position on a pressurized gas source valve, in particular a pressurized breathable gas cylinder, the tightening mechanism ensures the tightening of a portion of the valve on the inlet connector via the insert located between the valve and the inlet connection,
the tightening mechanism includes a screw screwed onto the yoke,
the inlet connection delimits an internal gas passage and includes a gas filter located in this passage,
in the installed position, the upstream seal of the insert is located on an upstream terminal end of the insert which is perpendicular to the outer cylindrical periphery of the inlet connection, i.e. the upstream seal of the insert is designed to cooperate in a sealed manner by contact with a surface perpendicular to the longitudinal axis of the insert.

The invention can also relate to an inlet connection for a first-stage pressure reducing device for pressurized breathable gas for a diver according to one of the characteristics described above or below including a body with a tubular shape extending around a central longitudinal axis, wherein the connection includes an upstream end with a cylindrical outer shape provided with a seal and a downstream end including a clamping mechanism, such as a thread, designed to cooperate with a mating clamping mechanism of a pressure reducing valve body, and the upstream end of the connection includes a cylindrical portion provided with a seal, wherein the seal is located on the outer cylindrical periphery of the inlet connection.

The invention can also relate to any alternative device or method including any combination of the characteristics described above or below.

Additional features and advantages are described below, with reference to the accompanying figures in which:

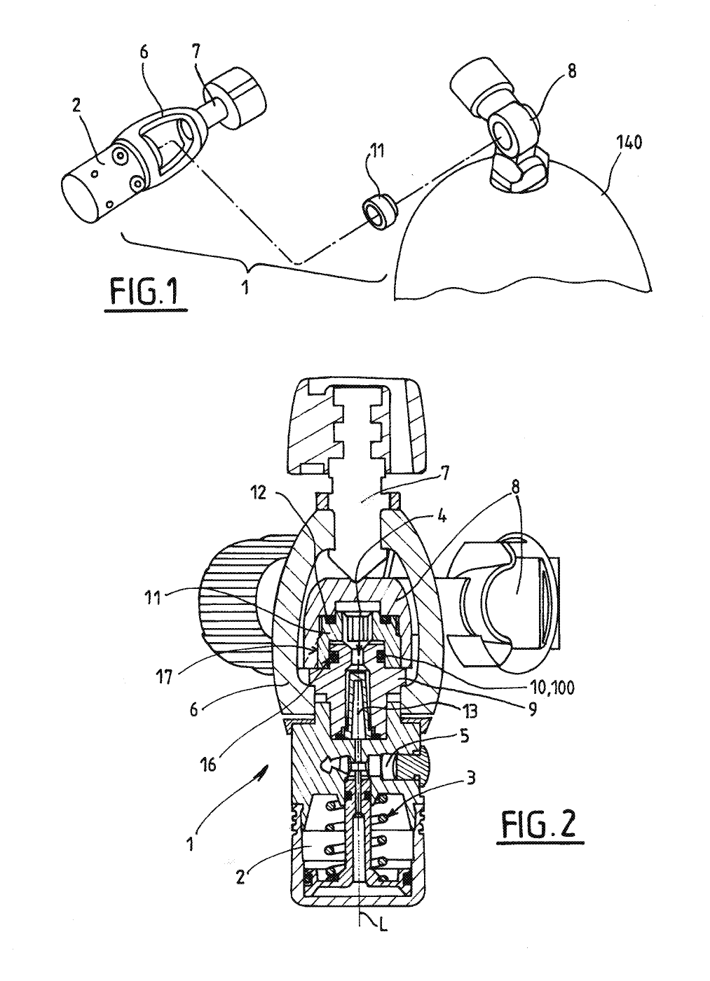

FIG. 1 is a schematic and partial view in perspective illustrating one example of a yoke-type first-stage pressure reducing device in the disassembled position in relation to the valve of a pressurized gas cylinder,

FIG. 2 is a schematic and partial view in longitudinal section illustrating one exemplary embodiment of the pressure reducing device illustrated in FIG. 1, in the assembled position,

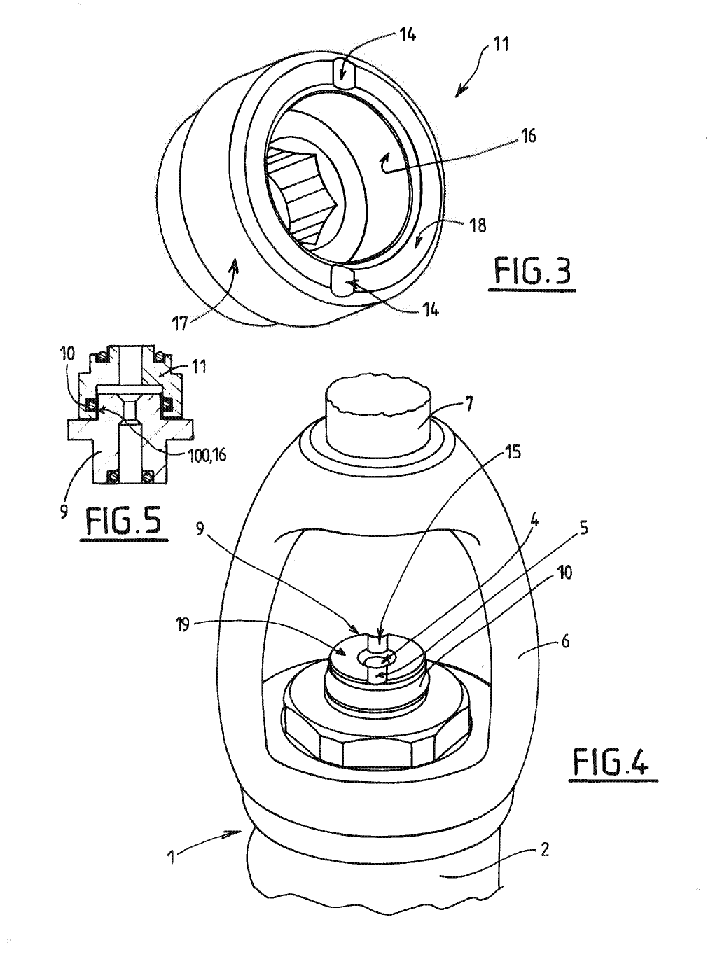

FIG. 3 is a schematic and partial view in perspective illustrating one exemplary embodiment of the downstream end of an adapter insert for a valve of the device illustrated in FIG. 1,

FIG. 4 is a schematic and partial view in perspective illustrating a detail of an exemplary embodiment of the pressure reducing device illustrated in FIG. 2, without connection to a valve.

The first-stage pressure reducing device 1 illustrated in the accompanying figures is of the yoke type 6. This pressure reducing device includes a body 2 that conventionally houses a gas circuit 3 including an inlet 4 for pressurized gas formed at the level of an inlet connection 9 and a depressurized gas outlet 5 (not visible in FIG. 2, but symbolically illustrated in FIG. 2 inside the circuit 3).

The pressure reducing device 1 includes a pressure regulator 3 located between the inlet 4 and the outlet 5, i.e. a mechanism that reduces the pressure of the gas between the inlet and the outlet to a specified value. For example, the pressure regulator 3 is of the piston and/or membrane type.

The pressure reducing device 1 includes a yoke 6 that is rigidly fastened to the body 2. For example, the yoke 6 is rigidly and detachably fastened to the body 2 of the pressure reducing device 1 via the inlet connection 9 which can be screwed into the body 10 by fitting a lower end of the yoke 6 over the body 2. In other words, the inlet connection 9 can conventionally be detachably fastened to the body 2 of the pressure reducing device 1 and can keep the yoke 6 rigidly fastened to the body 2.

An upper end of the yoke 6 supports a mechanism 7 that is mobile relative to the yoke 6 (in the up/down direction of the yoke 6), for example a screw 7, which is used to tighten or loosen a pressurized gas source valve 8 at the level of the inlet 4 of the body 2.

The inlet connection 9 includes an upstream end with a cylindrical outer shape positioned around the inlet 4 for the gas and provided with a sealing region 100 or seal surface 100 including a seal 10 located around this inlet 4. This seal 10 is designed to ensure the seal between a valve 8 of a cylinder and the pressure reducing device 1 when the pressure reducing device 1 is connected to a valve 8 of this type.

In one advantageous embodiment, the seal 10 is located on the outer cylindrical periphery of the inlet connection 9.

In other words, the seal 10 (preferably an O-ring) is placed in a radial groove located on the outer periphery of the end of the pressure reducing device (see FIG. 2). The term “outer” refers to the radial direction from the interior toward the outer of the tubular connection.

In other words, the inlet connection 9 has a tubular shape that extends around a central longitudinal axis L and the seal 10 is located on one face of the outer cylindrical periphery of the inlet connection 9 which is concentric and parallel to the central longitudinal axis L.

Therefore, the seal 10 is not located on the terminal surface of the inlet connector 9 which is perpendicular to the longitudinal axis L.

In other words, the seal 10 of the inlet connection 9 preferably emerges on the outer periphery of the connection 9 where it cooperates to form a seal with a wall 16 or bushing of a tubular part 11 arranged concentrically around the upstream end of the connection 9 and of the seal 10 (see FIG. 2).

As illustrated in FIG. 2, the inlet connection 9 delimits an internal gas passage which can include a gas filter 13 integrated into this passage.

On account of this new architecture of the upstream end of the inlet connection 9, the part 11 that forms an adapter insert (or adapter) is consequently modified so that it can create a seal with this radial seal 10.

This adapter insert 11 is installed on or is rigidly connected to a valve 8. The adapter insert 11 is also detachably installed on the upstream end of the inlet connector 9. The insert 11 has a generally tubular shape that extends around a longitudinal direction (L) between a first upstream end (cooperating with the valve 8 in the assembled position) and a second downstream end (cooperating with the inlet connection 9 in the assembled position). See FIG. 2.

For example, in the assembled position, the first downstream end of the insert 11 is concentrically engaged around the upstream end of the connection 9 and the seal 10. This downstream end [of the] insert 11 includes, for example, a cylindrical internal wall 16 that comes into sealed contact with the O-ring 10, concentrically around the latter.

The first downstream end of the insert 11, for its part, is designed to cooperate in a sealed manner with a valve 8 of a pressurized gas cylinder 140.

This architecture makes it possible to more effectively retain the O-ring 10 in its groove. In effect, this seal 10 is less susceptible to being accidentally extracted from its groove during a disassembly of the pressure reducing device 1 or if the seal 10 is moist or wet.

Moreover, according to this solution, it is not necessary to apply a tightening torque to ensure that the connection is sealed.

The deformation of the seal 10 (preferably made of elastomer) can be controlled by the correct sizing of this O-ring 10.

This new structure does not call into question the structure of the valves 8 of cylinders 14 currently on the market because a specific adapter (insert 11) can be installed in place of the current adapter (current insert).

As is visible in FIG. 2, the first upstream end of the insert 11 can include a seal 12, such as an O-ring, for example, designed to cooperate in a sealed manner in particular with one face of the valve 8.

The seal 12 of the insert 11 is preferably located on an upstream terminal end of the insert 11, in particular on a surface which is perpendicular to the outer cylindrical periphery of the inlet connection 9. In other words, the seal 12 of the upstream end of the insert 11 is designed to cooperate in a sealed manner by frontal contact with a surface perpendicular to the longitudinal axis L of the insert 11 (see FIG. 2).

The insert 11 includes, for example, a threaded outer portion 17 designed to cooperate by forming a threaded connection with a mating portion of a valve 8 that will receive the pressure reducing device 1.

When the pressure reducing device is installed on the valve, the first downstream end of the insert 11 is fitted over the upstream cylindrical end of the connection 9.

Therefore, when the pressure reducing device is installed on a valve 8, the tightening screw 7 can tighten a portion of the valve 8 on the inlet connector 9 via the insert 11 located between the valve 8 and the inlet connection 9 of the pressure reducing device.

As illustrated in FIG. 3, the downstream terminal end of the insert 11 can include an annular surface 18 perpendicular to the longitudinal direction L of the insert. This surface 18 preferably includes at least one groove 14, for example two grooves 14, formed in its thickness dimension to inhibit, in the assembled position, a contact seal between the surface 18 and a parallel mating surface of a connection 9, which would not be in accordance with the geometry described above.

In other words, for safety reasons, the structure of the adapter insert 11 according to the invention does not allow the connection, on this insert 11, of a pressure reducing device that has a connection of the prior art (standard ISO 12209).

Preferably, the centering diameters of the surface 18 and of a connection of the prior art are different. Moreover, the groove or grooves 14 on the end face 18 do not allow a metal-to-metal seal in the case of the connection of a system of the prior art on such an insert 11.

Likewise, the upstream terminal end of the inlet connection 9 can include a surface 19 perpendicular to the outer cylindrical periphery of the inlet connection 9 (see FIG. 4). The surface 19 includes at least one groove 15 to also prevent, in the installed position, a frontal contact seal of this surface 19 with a mating surface of an insert 11 or of a valve 8 of the prior art.

In other words, a yoke-type pressure reducing device 1 provided with this architecture is not functionally compatible (because it cannot create a seal) with an adapter insert of the prior art (that complies with standard ISO 12209). In effect, the groove or grooves 15 prevent any possible frontal seal with a conventional adapter.

Of course, the venting groove or grooves 14, 15 can be replaced by any other geometry or surface roughness that prevents a seal with known devices (i.e. that comply with standard ISO 12209).

The invention is not limited to the example described above. Therefore, and as illustrated in FIG. 5, the seal 10 that creates a seal between the connection 9 and the adapter insert 11 can be located on the insert 11 (instead of the connection 9), and thereby cooperate in sealed contact with the sealing region 100 of the connection 9 (on the outer cylindrical surface). In other words, the seal 10 of the insert 11 is placed concentrically around the connection 9.

1. First-stage pressure reducing device for pressurized breathable gas for a diver, wherein the pressure reducing device (1) is of the type having a yoke (6) and includes a body (2) that houses a gas circuit (3) including a pressurized gas inlet (4) formed at the level of an inlet connection (9), a depressurized gas outlet, a pressure regulator (3) located between the inlet (4) and the outlet (5), a yoke (6) rigidly connected to the body (2) and supporting a clamping mechanism (7) that is mobile relative to the yoke (6) to ensure the tightening or loosening of a pressurized gas source valve (8) at the level of the inlet (4) of the body (2), the inlet connection (9) includes an upstream end with a cylindrical outer shape positioned around the inlet (4), the upstream end of the connection (9) includes a sealing region (100) around the inlet (4), the sealing region (100) includes a seal (10) and/or is designed to cooperate with a seal (10) of a valve or an adapter of a valve to ensure a seal between a valve (8) of a pressurized gas source and the pressure relief device (1) when the pressure relief device (1) is connected to a valve (8), characterized in that the sealing region (100) is located on the outer cylindrical periphery of the inlet connection (9).

2. Device according to claim 1, characterized in that the inlet connection (9) has a tubular shape that extends around a central longitudinal axis (L), and that the sealing region (100) is located on a face of the outer cylindrical periphery of the inlet connection (9) which is concentric and parallel to the central longitudinal axis (L).

3. Device according to claim 1, characterized in that the connection (10) includes a seal (10) located at the level of the sealing region (100).

4. Device according to claim 3, characterized in that it includes an O-ring (9) housed in a groove located radially on the periphery of the connection (9).

5. Device according to claim 3, characterized in that the seal (10) of the connection (9) emerges radially on the outer periphery of the connection (9), to cooperate in a sealed manner with a wall of a tubular part (11) located concentrically around the upstream end of the connection (9) and of the seal (10).

6. Device according to claim 1, characterized in that the sealing region of the connection (9) does not have a seal, the device includes an adapter insert (11) that is firmly connected to a valve (8), said insert (11) is designed to be detachably installed on the upstream end of the inlet connection (9), the insert (11) includes a tubular shape that extends around a longitudinal direction (L) between a first upstream end and a second downstream end, in the assembled position, the downstream end of the insert (11) is engaged concentrically around the upstream end of the connection (9), the downstream end of the insert (11) includes a cylindrical internal wall (16) provided with a seal (10) which comes into sealed contact against the sealing region (100) of the connection (9).

7. Device according to claim 3, characterized in that it includes a connection adapter insert (11) designed so that it can be detachably installed on the upstream end of the inlet connection (9), the insert (11) has a tubular shape that extends around a longitudinal direction (L) between a first upstream end and a second downstream end, in the assembled position, the downstream end of the insert (11) is engaged concentrically around the upstream end of the connection (9) and of the seal (10), the downstream end of the insert (11) includes a cylindrical internal wall (16) that comes into sealed contact with the seal (10), radially around the latter.

8. Device according to claim 7, characterized in that the first upstream end of the insert (11) is designed to cooperate in a sealed manner with a valve (8) of a pressurized gas source.

9. Device according to claim 8, characterized in that the first upstream end of the insert (11) includes an upstream seal (12) designed to cooperate in a sealed manner with a valve (8) of a pressurized gas source.

10. Device according to claim 6, characterized in that, in the assembled position, the second downstream end of the insert (11) is fitted onto the upstream end of the connection (9) and in that the insert (11) includes a threaded or tapped portion designed to cooperate with a mating portion of a source valve (8) connected to the pressure reducing device (1).

11. Device according to claim 6, characterized in that the downstream terminal end of the insert (11) includes a surface (18) perpendicular to the longitudinal direction (L), and said surface (18) includes at least one groove (14) to prevent, in the assembled position, a contact seal between the surface (18) and a parallel mating surface of a connection (9).

12. Device according to claim 1, characterized in that the upstream terminal end of the inlet connection (9) includes a surface (19) perpendicular to the outer cylindrical periphery of the inlet connection (9), and said surface (19) includes at least one groove (15) to inhibit, in the assembled position, a frontal contact seal of this surface (19) with a mating surface of an insert (11) or of a valve (8).

13. Inlet connection (9) for a first-stage pressure reducing device for pressurized breathable gas for a diver according to claim 1, including a body having a tubular shape extending around a central longitudinal axis (L), the connection (9) includes an upstream end with a cylindrical outer shape provided with a seal (10) and a downstream end including a clamping mechanism designed to cooperate with a mating clamping mechanism of a body (2) of the pressure reducing valve (1), the upstream end of the connection (9) includes a cylindrical portion provided with a seal (10), characterized in that the seal (10) is located on the outer cylindrical periphery of the inlet connection (9), and in that the clamping mechanism of the downstream end of the connection is a thread for screwing onto the body of a pressure reducing device.
